(19) United States
(12) Patent Application Publication
(10) Pub. No.: US 2008/0280618 A1
(43) Pub. Date: Nov. 13, 2008

(54) METHOD OF DISTRIBUTING IDENTICAL DATA AND DIFFERENT DATA TO MOBILE UNITS

(76) Inventors: Tjietse Van Der Gaast, Huizen (NL); Geert Jan Hoekstra, Amersfoort (NL)

Correspondence Address: Mark W. Sincell, Ph.D.;Williams, Morgan & Amerson, P.C., Suite 1100, 10333 Richmond, Houston, TX, 77042, US

(21) Appl. No.: 11/745,760

(22) Filed: May 8, 2007

(51) Int. Cl. H04Q 7/20

(52) U.S. Cl. 455/445

(57) ABSTRACT

The present invention provides a method of distributing identical data and different data to mobile units. One embodiment of the method may include providing a plurality of first messages including information indicative of a first pseudo-address. Each first message includes information indicative of an address of one of a plurality of mobile units. The method may also include providing at least one second message including information indicative of at least one second pseudo-address and information indicative of the address of each mobile unit in at least one subset of the plurality of mobile units. The method further includes providing at least one third message including the first pseudo-address and a portion of a packet destined for the plurality of mobile units. At least one fourth message including the second pseudo-address and a portion of a packet destined for the subset of the plurality of mobile units is also included.

### CROSS REFERENCE TO RELATED APPLICATIONS

This application is related to the U.S. patent application as filed on Jul. 31, 2006, Ser. No. 11/461,054 entitled “Method of Distributing Identical Data to Mobile Units.”

### BACKGROUND OF THE INVENTION

1. Field of the Invention

This invention relates generally to communication systems, and, more particularly, to wireless communication systems.

2. Description of the Related Art

Conventional wireless communication systems typically include one or more devices that provide wireless connectivity over an air interface. Depending upon the type of wireless access technology implemented in the wireless communication system, the devices may include base stations, base station routers, access points, and the like. For example, in a cellular telephone system such as a Universal Mobile Telecommunication System (UMTS) or a Global System for Mobile communication (GSM), base stations may be used to provide wireless connectivity within associated geographic areas or cells. For another example, in a WiFi system or a short-range wireless communication system implemented in accordance with Bluetooth or one of the IEEE standards, an access point may be used to provide wireless connectivity within a hotspot, such as an airport terminal or a coffee shop.

Mobile units may communicate with the base stations over the air interface. Exemplary mobile units may include cellular telephones, personal data assistants, smart phones, paging devices, text messaging devices, global positioning system (GPS) devices, network interface cards, notebook computers, desktop computers, and the like. For example, mobile units may transmit and/or receive messages including voice and/or data information, signaling information, paging messages, broadcast messages, and the like. The base stations are typically communicatively coupled to one or more networks so that the mobile units may communicate with other devices that are also communicatively coupled to the networks. For example, one mobile unit may establish a wireless communication link with another mobile unit via a network coupled to the associated base stations. For another example, mobile units may receive information from a server attached to the network.

Servers attached to the network may transmit information to mobile units using either point-to-point communication techniques or point-to-multipoint communication techniques, which conventionally include multicast and/or broadcast techniques. In point-to-point communication, e.g., from the server to a specific mobile unit, transmitted packets include a packet header that includes information indicative of the mobile unit, such as a media access control (MAC) layer address. The packet may then be transmitted to a base station associated with the mobile unit and the base station may transmit the packet over the air interface. Each packet may be divided up into a number of messages for transmission over the air interface. Each message includes the relevant mobile unit address and a portion of the payload of the original packet. Since the air interface is a shared medium that may carry packets or messages destined for many different mobile units, each mobile unit only “listens” to packets or messages that include the mobile unit's address.

Point-to-multipoint communication permits a server to transmit the same information to more than one mobile unit. For example, users of mobile units may be subscribed to receive a pay-per-view television program provided by a server. The subscribed mobile units may be assigned a multicast or broadcast address for the point-to-multipoint transmission. The server then transmits information to the broadcast/multicast address and the subscribed mobile units “listen” for transmission associated with this address. Thus, the server may multicast the pay-per-view television program to all of the subscribed mobile units by multicasting or broadcasting a stream of packets representative of the pay-per-view television program to the subscribed mobile units using the multicast/broadcast address.

Service providers are increasingly interested in providing information that is tailored to specific users or groups of users. For example, service providers may wish to personalize the services that they provide by tailoring the information to appeal to individual or groups that share certain characteristics such as a certain lifestyle, personal interests, and the like. Service providers may also be interested in including unique identifiers in some of the broadcast information (e.g., watermarking the information) to indicate the identity of the original receiver of the information. Water marking information in this way may reduce or prevent undesired and/or unauthorized reproduction of the information content. However, neither point-to-point nor point-to multipoint transmission techniques are perfectly suited to transmitting personalized and/or customized information that includes a portion that is transmitted to all the users and a portion that is unique to a single user or group of users.

Point-to-point transmission is well-suited to providing unique information to different users at different mobile unit addresses, but is not the best solution for broadcasting the same information to multiple users. For example, in a point-to-point system, information that is intended to be received by all of the users in a group, or a large percentage of the users in the group, must be duplicated in each of the independent data streams that are directed to the different mobile unit addresses associated with the users in the group. Transmitting duplicate information to mobile units at different addresses may consume an undesirably large portion of the scarce radio transmission resources associated with the air interface, potentially reducing the capacity of the air interface. In contrast, point-to-multipoint transmission is well-suited to transmitting identical information to different users that share a single multicast or broadcast address. However, the same information must be transmitted to all the users that share the single multicast or broadcast address, so point-to-multipoint transmissions cannot be used to transmit personalized or customized information to some of the users in a multicast group.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for distributing identical data and different data to mobile units. One embodiment of the method may include providing a plurality of first messages including information indicative of a first pseudo-address. Each first message also includes information indicative of an address of a corresponding one of a plurality of mobile units. The method may also include providing at least one second message including information indicative of at least one second pseudo-address and information indicative of the address of each mobile unit in at least one subset of the plurality of mobile units. The method further includes providing at least one third message including the first pseudo-address and a portion of a packet destined for the plurality of mobile units. At least one fourth message including the second pseudo-address and a portion of a packet destined for the subset of the plurality of mobile units is also included.

In another embodiment of the present invention, a method is provided for receiving identical data and different data at one of a plurality of mobile units. One embodiment of the method may include receiving, at a mobile unit included in a plurality of mobile units, a first message including information indicative of a first pseudo-address associated with the plurality of mobile units. The first message includes information indicative of an address of the mobile unit. The method may also include receiving, at the mobile unit, at least one second message including information indicative of at least one second pseudo-address associated with a subset of the plurality of mobile units and information indicative of the address of the mobile unit. The subset includes the mobile unit. The method further includes receiving, at the mobile unit, at least one third message including the first pseudo-address and a portion of a packet destined for the plurality of mobile units. At least one fourth message including the second pseudo-address and a portion of a packet destined for the subset of the plurality of mobile units may be received at the mobile unit.

### BRIEF DESCRIPTION OF THE DRAWINGS

The invention may be understood by reference to the following description taken in conjunction with the accompanying drawings, in which like reference numerals identify like elements, and in which:

FIG. 1A conceptually illustrates a first exemplary embodiment of a wireless communication system, in accordance with the present invention;

FIG. 1B conceptually illustrates a second exemplary embodiment of a wireless communication system, in accordance with the present invention;

FIG. 1C conceptually illustrates one exemplary embodiment of multiple data streams that may be transmitted in the first or second exemplary embodiments of the wireless communication systems shown in FIGS. 1A-B, in accordance with the present invention;

FIG. 2 conceptually illustrates a first exemplary embodiment of a technique for fragmenting a packet, in accordance with the present invention;

FIG. 3 conceptually illustrates a second exemplary embodiment of a technique for fragmenting a packet, in accordance with the present invention; and

FIG. 4 conceptually illustrates one exemplary embodiment of a method of distributing data to mobile units, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and custom-ary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

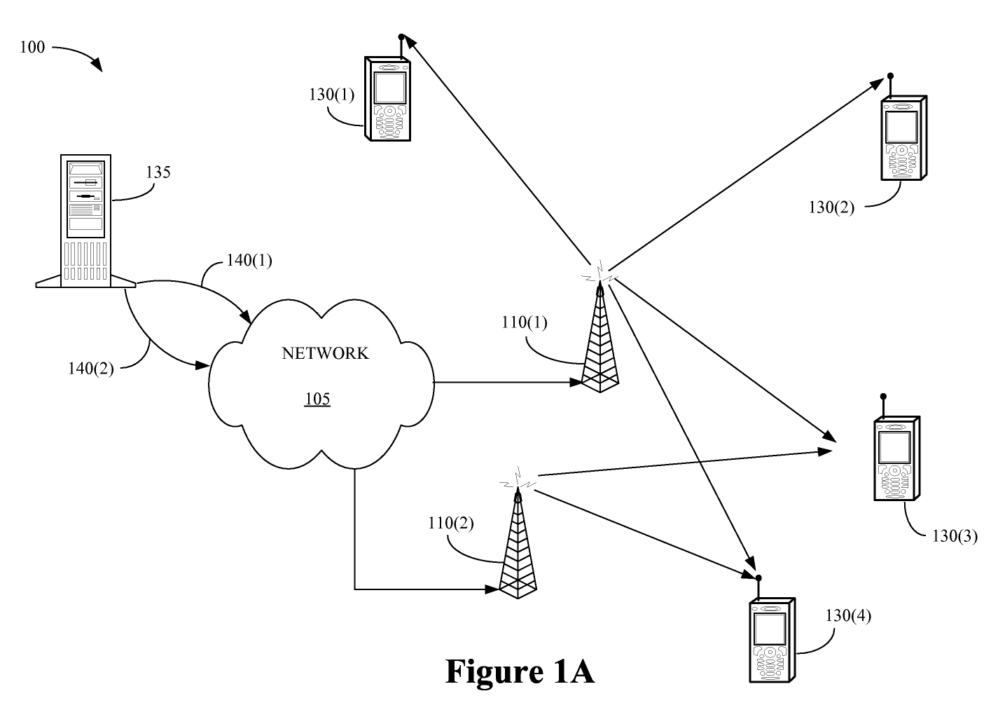

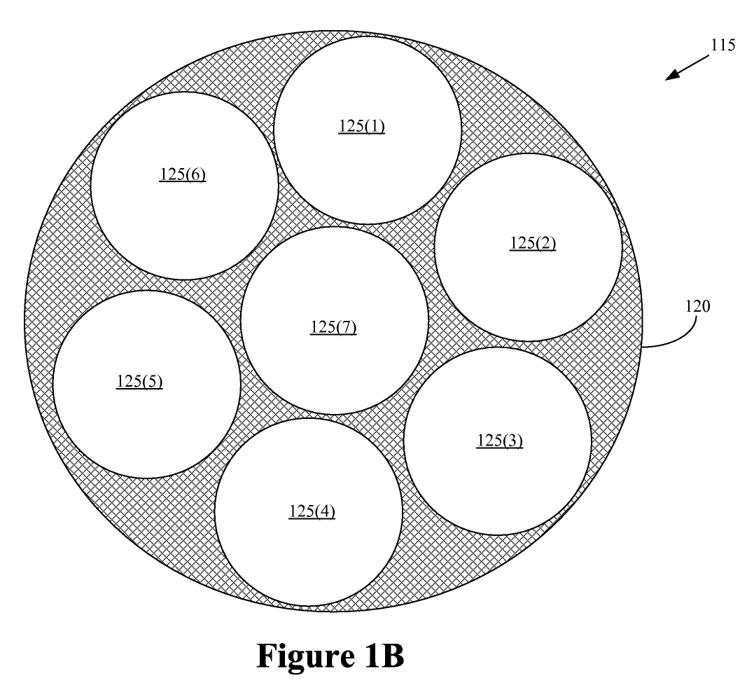

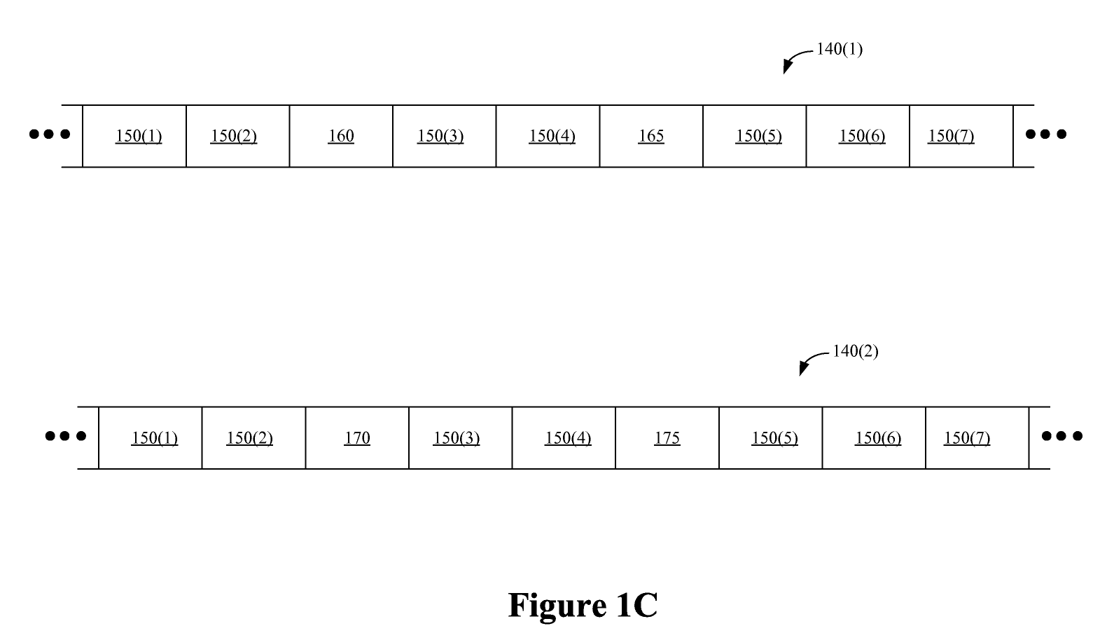

FIG. 1A conceptually illustrates a first exemplary embodiment of a wireless communication system 100. In the illustrated embodiment, the wireless communication system 100 includes a network 105. The network 105 is used to transmit packets between various destinations and may include wired and/or wireless portions. Accordingly, the network 100 may operate according to the Internet Protocol (IP), as well as various other wired and/or wireless communication standards and/or protocols, such as set forth for the Universal Mobile Telecommunication System (UMTS), the Global System for Mobile communications (GSM), Code Division Multiple Access (CDMA, CDMA 2000), WiFi, Bluetooth, the IEEE 802 standards, the Point-to-Point Protocol (PPP), the User Datagram Protocol (UDP), and the like.

One or more access points 110(1-2) are communicatively coupled to the network 105. The indices (1-2) may be used to indicate individual access points 110(1-2) or subsets thereof. However, the indices (1-2) may be dropped when referring to the access points 110 collectively. This convention may be applied to other elements shown in the drawings and referred to using a number and one or more distinguishing indices. In the illustrated embodiment, the access points 110 provide wireless connectivity according to WiFi standards and/or protocols. However, persons of ordinary skill in the art having benefit of the present disclosure should appreciate that the present invention is not limited to access points 110 that operate according to WiFi standards and/or protocols. In alternative embodiment, any device or combination of devices capable of providing wireless connectivity may be used in place of, or in addition to, the access points 110. For example, base stations, base station routers, and similar devices may alternatively be used to provide wireless connectivity in the wireless communication system 100.

In the illustrated embodiment, the access points 110 are configured to provide wireless connectivity to different types of cells. For example, the access point 110(1) may include an isotropic antenna that is capable of providing wireless connectivity over an approximately circular area that may extend to approximately the same radius in all directions. However, persons of ordinary skill in the art having benefit of the present disclosure will appreciate that a perfectly circular coverage area is an idealization and that the actual coverage area may be irregular and/or time varying, e.g., as a result of environmental conditions, fading, and/or obstructions within the coverage area. In contrast, the access point 110(2) may include a directional antenna to provide wireless connectivity within an angle centered on a selected direction. Alternatively, the access point 110 may provide wireless connectivity to cells of different sizes by transmitting at different powers or according to different standards and/or protocols. For example, the access point 110(1) may provide wireless connectivity to a relatively large area according to UMTS standards and/or protocols and the access point 110(2) may provide wireless connectivity to a relatively small area according to WiMAX standards and/or protocols. Persons of ordinary skill in the art having benefit of the present disclosure should appreciate that these exemplary cell types are intended to be illustrative and not to limit the present invention.

FIG. 1B conceptually illustrates a second exemplary embodiment of a wireless communication system 115. In the illustrated embodiment, wireless coverage is provided to overlapping areas using access points that provide wireless connectivity to different cell types. One coverage type or cell type is used to provide wireless connectivity to the relatively large area 120, indicated by the crosshatching. As discussed above, persons of ordinary skill in the art having benefit of the present disclosure should appreciate that the circular area 120 is an illustrative idealization of an actual coverage area. A second coverage type or cell type is used to provide wireless connectivity to the relatively small areas 125. In the illustrated embodiment, the relatively small areas 125 completely overlap the relatively large area 120 and are encompassed by the relatively large area 120. However, persons of ordinary skill in the art having benefit of the present disclosure should appreciate that this configuration is intended to be illustrative and the present invention is not limited to this particular configuration of large and small areas.

Referring back to FIG. 1A, the wireless communication system 100 also includes a plurality of mobile units 130. Exemplary mobile units may include cellular telephones, personal data assistants, smart phones, paging devices, text messaging devices, global positioning system (GPS) devices, network interface cards, notebook computers, desktop computers, and the like. Although FIG. 1 shows four mobile units 130, persons of ordinary skill in the art having benefit of the present disclosure should appreciate that the wireless communication system 100 may provide wireless connectivity to any number of mobile units 130. In one embodiment, the mobile units 130 may establish wireless communication links with one or more of the base stations 110. For example, the mobile units 130(1) and 130(4) may establish a point-to-point connection via the base stations 110 and the network 105 so that users of the mobile units 130(1) and 130(4) may communicate, e.g., the users may have a conversation. The mobile units 130 may also receive point-to-multipoint, e.g. broadcast or multicast, transmissions via one or more of the base stations 110.

In the illustrated embodiment, the wireless communication system 100 includes one or more servers 135 (only one shown in FIG. 1A) that are configured to provide streams 140 of information to one or more of the mobile units 130. The streams 140 may include portions that are substantially identical. As used herein, the term “substantially” is meant to indicate that the information in the portions of the multiple streams 140 is intended to convey the same content at approximately the same time, within a selected tolerance. However, persons of ordinary skill in the art having benefit of the present disclosure should appreciate that the information (or the representation of the information) in the substantially identical portions of the streams 140 may not be perfectly identical and may not be provided at precisely the same time. The differences may be intentional, e.g., when different service levels are provided, or unintentional, e.g., due to interference, travel time differences, and the like. For example, the users of the mobile units 130 shown in FIG. 1 may have subscribed to one or more multicast services, such as IPTV or a pay-per-view service, provided by the server 135. The server 135 may provide the multiple streams 140 of multicast data to the base stations 110 via the network 105. The base stations 110 may then transmit the information included in the multiple streams 140 to one or more of the mobile units 130 over the air interface. For example, the server 135 may broadcast or multicast streams 140 that include information that may be used by the mobile units 130 to form output that plays a football match to the users of the mobile units 130.

The service provider may also wish to tailor or personalize some of the information transmitted in the streams 140 to particular users. For example, a service provider may wish to provide particular kinds of commercials to the users operating the subset of mobile units 130(3-4). For another example, if the football match is between Manchester United and Bayern Munich, some of the users may have subscribed to an English-language version of the commentary for the football match and other users may have subscribed to a German language version of the commentary. The server 135 may therefore include one or more packets in the streams 140 that are only intended to be transmitted to a subset of the mobile units 130(3-4). Although only a single subset of the mobile units 130(3-4) is shown in FIG. 1A, persons of ordinary skill in the art having benefit of the present disclosure should appreciate that the present invention is not limited to any particular number of subsets of the mobile units 130. In alternative embodiments, any number of subsets including any number of mobile units 130 may be included in the wireless communication system 100. Furthermore, persons of ordinary skill in the art having benefit of the present disclosure should appreciate that subsets may overlap so that some mobile units 130 belong to multiple subsets.

Each of the multiple streams 140 includes packets addressed to one or more of the subscribed mobile units 130. Headers of the packets included in the multiple streams 140 may therefore include destination addresses of the associated subscribed mobile unit 130, such as addresses of individual mobile units 130, addresses of subsets of mobile units 130, and group addresses for the mobile units 130 that are subscribed to a broadcast or multicast service. Payloads of some of the packets transmitted in the multiple streams 140 may include substantially the same information and may be transmitted substantially simultaneously, e.g., the packets that include the visual portion of the football match. As used herein, the term “substantially” is meant to indicate that the packets in the multiple streams 140 convey information indicative of the same content at approximately the same time, within a selected tolerance. However, persons of ordinary skill in the art having benefit of the present disclosure should appreciate that the transmitted and/or received packets in each stream 140 may not be precisely identical and may not arrive at the mobile units 130 at precisely the same time. The differences may be intentional, e.g., when the mobile units 130 subscribe to different service levels, or unintentional, e.g., due to interference, travel time differences, and the like. Payloads of other packets transmitted in the multiple streams 140 may include different information, e.g., information that is tailored to users in a subset of the mobile units 130(3-4).

FIG. 1C conceptually illustrates one exemplary embodiment of the multiple data streams 140 that may be transmitted in the first or second exemplary embodiments of the wireless communication systems 100, 115 shown in FIGS. 1A-B. In the illustrated embodiment, the multiple data streams 140 include substantially identical packets 150. For example, the packets 150 may include information intended for a multicast group of mobile units. The multiple data streams 140 also include non-identical packets 160, 165, 170, 175. For example, the packets 160, 165 may be intended for one or more mobile units in a first subset of the multicast group and the packets 170, 175 may be intended for one or more mobile units in a second subset of the multicast group.

Referring back to FIG. 1A, the network 105 receives the multicast streams 140 provided by the server 135. An entity within the network 105 may then determine which portions of the multicast streams 140 are identical and which portions are intended for individual mobile units 130 and/or subsets of the mobile units 130. Exemplary entities that may perform this determination include, but are not limited to, a Gateway GPRS Support Node or Serving GPRS Support Node (e.g., in a cellular network), or an Access Gateway in a UMTS-Long Term Evolution network. In the illustrated embodiment, the network 105 determines that the streams 140 include identical packets 150 that are intended to be transmitted to all of the mobile units 130. For example, the entity within the network may determine that the packets 150 include substantially identical information and/or have arrived within a specified tolerance time. The entity within the network 105 may also determined that the streams 140 include packets 160, 165, 170, 175 that are intended to be transmitted to individual mobile units 130 and/or subsets of the mobile units 130. For example, the packets 160, 165, 170, 175 may not include substantially identical information and/or may have arrived outside of the specified tolerance time.

The packets 150, 160, 165, 170, 175 in the streams 140 may then be fragmented into multiple messages. The packets 150 that are addressed to the multicast group including the mobile units 130 may be fragmented into one or more messages that include the multicast group address. The mobile units 130 know that messages that include the multicast group address are intended for them and so the mobile units 130 “see” or “listen to” messages that include this address. In the illustrated embodiment, the streams 140 are directed to different multicast group addresses, even though the mobile units 130 indicated by these addresses may be the same. For example, different applications within the server 135 (or different servers) may be transmitting the different streams 140 and so may assign different group addresses to the mobile units 130. Consequently, multiple messages including the different multicast group addresses (and a substantially identical first portion of the packets 150) may be transmitted to the mobile units 130.

The messages that are addressed to the mobile units 130 using the multicast group addresses also include a pseudo-address that indicates to the mobile units 130 that they should also “see” or “listen to” subsequent messages that include the pseudo-address. A single pseudo-address is indicated in the messages that are addressed to the mobile units 130 using the multicast group addresses. Subsequent messages may then be formed from substantially identical portions of the packets 150 and transmitted to the mobile units 130 using the pseudo-address. Since the mobile units 130 “see” or “listen to” messages address to the pseudo-address, only one message is needed to transmit each subsequent fragment of the packets 150. Thus, the redundant transmission of identical portions of the packets 150 may be reduced and/or eliminated.

The packets 160, 165, 170, 175 that are addressed to individual mobile units 130 or subsets of the mobile units 130 may also be fragmented into one or more messages that include the addresses of the mobile units 130. Multiple messages including the different mobile unit addresses (and a portion of one or more of the packets 160, 165, 170, 175) may be transmitted to the mobile units 130, which “see” or “listen to” messages that include their address. The messages that are addressed to the mobile units 130 using the mobile unit addresses also include a pseudo-address that indicates to the mobile units 130 that they should also “see” or “listen to” subsequent messages that include the pseudo-address. Subsequent messages may then be formed from portions of the packets 160, 165, 170, 175 and transmitted to the mobile units 130 using the pseudo-address associated with an individual mobile unit 130 or a subset of the mobile units 130. These pseudo-addresses are different than the pseudo-addresses associated with the fragments of the substantially identical packets 150 and so the information in the non-identical packets 160, 165, 170, 175 may be transmitted over different pathways than the information in the identical packets 150, as will be discussed in detail below.

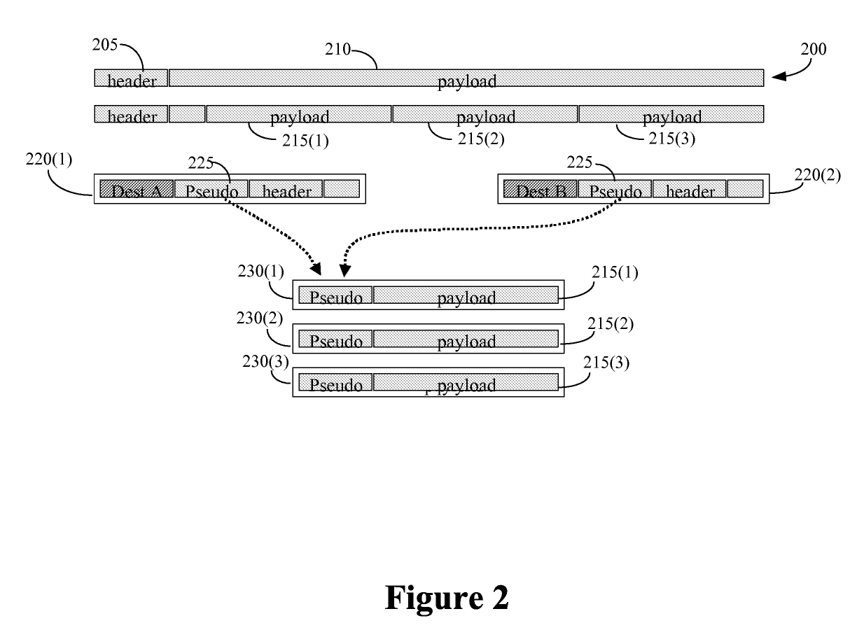

FIG. 2 conceptually illustrates a first exemplary embodiment of a technique for fragmenting a packet 200. In the illustrated embodiment, the packet 200 is an IP packet that includes a header 205 and a payload 210. The packet 200 may be one of a plurality of substantially identical packets in multiple streams of data that are destined for multiple mobile units. In one embodiment, the substantially identical packets are part of one or more multicast or broadcast streams. Alternatively, the substantially identical packets may be included in multiple unicast (point-to-point) data streams that either intentionally or coincidentally contain substantially identical information. Alternatively, the packet 200 may be unique to a particular data stream and may be intended for individual mobile unit or a subset of a group of mobile units.

The packet 200 may be fragmented by dividing the payload 210 into portions 215. Although four portions 215 are shown in FIG. 2, persons of ordinary skill in the art having benefit of the present disclosure should appreciate that any number of portions 215 may be used. In various alternative embodiments, the number of portions 215 may be influenced by considerations such as the size of the payload 210, characteristics and/or capabilities of the transmitting device, the air interface, and/or the receiving device, and the like. Multiple messages 220 may be formed using portions of the packet 200. Each of the messages 220 is destined for different mobile units and so the messages 220 include information indicative of the destination mobile units (Dest A, Dest B). The messages 220 may also include the header 205 and, in some embodiments, a portion of the payload 210, although this is not depicted in FIG. 2.

The messages 220 also include information, referred to hereinafter as a pseudo-address 225, which allows the subscribed mobile units to determine that subsequent messages 230 are destined for the mobile units. In one embodiment, the pseudo-address 225 includes information that is different and distinct from the multicast group addresses and/or individual mobile unit addresses indicated in the packets 200. However, in alternative embodiments, any information may be used to form the pseudo-address 225 such that more than one mobile unit may access information in the messages 230.

The messages 220, 230 may be transmitted over an air interface to one or more mobile units. Each of the destination mobile units indicated in the messages 220 may receive the corresponding message 220 and use the included information to determine the pseudo-address 225. The destination mobile units may then receive the subsequent messages 230 using the pseudo-address 225. Consequently, in cases where the packet 200 includes information that is representative of substantially identical information that is to be transmitted to both of the destination mobile units (Dest A, Dest B), some or all of the payload 210 in the packet 200, which is one of a plurality of identical packets, may be transmitted to more than one destination mobile unit using a single group of messages 230 destined for all the mobile units. On the other hand, if the packet 200 includes information that is to be transmitted to an individual mobile unit or a subset mobile units within a larger group of mobile units, then the pseudo-address may be used to transmit this non-identical information to the individual mobile unit (or to the subset of mobile units) independently of information that is intended to be transmitted to a larger group of mobile units.

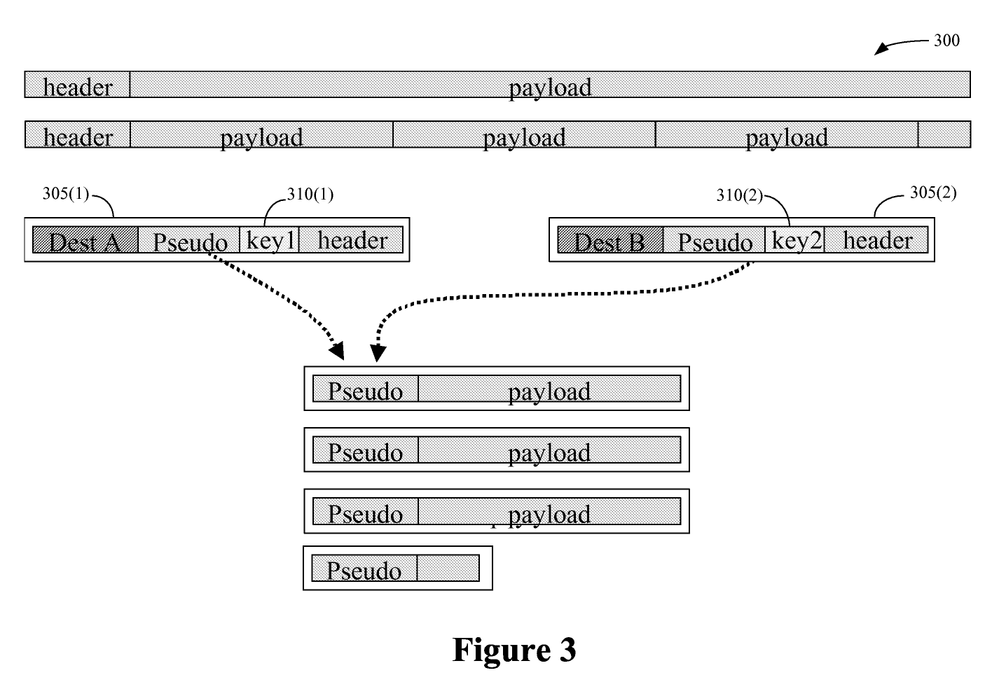

FIG. 3 conceptually illustrates a second exemplary embodiment of a technique for fragmenting a packet 300. The second exemplary embodiment is similar to the first exemplary embodiment shown in FIG. 2. However, the second exemplary embodiment differs from the first exemplary embodiment in that the initial messages 305 that are transmitted separately to the different destination mobile units also include one or more security keys 310, which may be used to encrypt and/or decrypt information transmitted in the subsequent messages 315. Accordingly, the second exemplary embodiment may provide additional security for transmissions over the air interface.

Referring back to FIG. 1A, the network 105, or an entity therein, may direct packet fragments to the base stations 110 using the pseudo-addresses associated with the identical information that is intended to be transmitted to the group of mobile units 130. The network 105, or an entity therein, may also direct packet fragments to the base stations 110 to the pseudo-addresses associated with the information intended to be transmitted to a subset of the group of mobile units 130(3-4). In the illustrated embodiment, messages that are addressed using the multicast group address and/or individual mobile unit addresses may be transmitted to both base stations 110 for subsequent transmission to the mobile units 130. However, subsequent messages that are addressed using the pseudo-address associated with a group of mobile units 130 may be directed to the base station 110(1), which is configured to transmit information to a first type of cell. For example, as discussed above, the base station 110(1) may be configured to transmit information approximately isotropically to the mobile units 130. Messages addressed using the pseudo-address associated with a subset of the mobile units 130(3-4) may be directed to the base station 110(2), which is configured to transmit information to a second type of cell. For example, as discussed above, the base station 110(2) may be configured to transmit information within a selected range of directions, such as the range of directions including a subset of the mobile units 130(3-4). The base stations 110 may then transmit the subsequent messages using the associated pseudo-addresses.

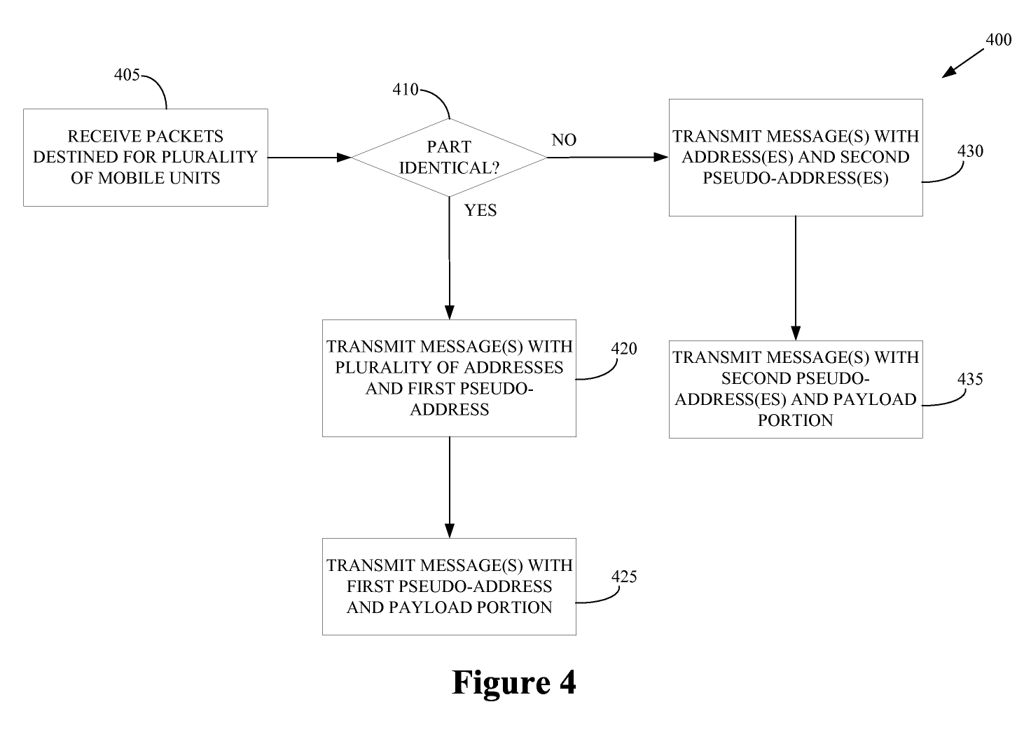

FIG. 4 conceptually illustrates one exemplary embodiment of a method 400 of distributing data to mobile units. In the illustrated embodiment, packets from multiple streams of data are received (at 405), e.g., at an entity within a network. The packets may then be analyzed to determine (at 410) whether two or more of the packets contain substantially identical information. In one embodiment, the contents of the packets may be compared to determine (at 410) whether packets contain substantially identical information. For example, packets may be randomly selected from different data streams and compared (at 410) to determine whether the packets are substantially identical. Alternatively, a tag or a token may be incorporated into packets in multiple streams to indicate that the tagged packets include substantially identical information. In that case, the packets may be examined for the presence of these tags and/or tokens.

In one embodiment, other information associated with the packets may be analyzed to determine (at 410) whether packets contain substantially identical information within a reasonable probability. For example, source addresses, destination ports, and error-checking bits (such as cyclic redundancy check bits) may be compared. If these addresses, ports, and error bits are the same for a packet, then it is very likely that these packets include substantially identical information. This embodiment may advantageously be able to determine (at 410) whether packets contain substantially identical information (at least within an acceptable probability) by comparing a smaller portion of the information included in the packets, thereby conserving scarce computation resources, e.g., at the access point, base station, base station router, or other entity.

In one embodiment, arrival times of the packets may also be analyzed (at 410) to determine whether the packets have arrived, or should be transmitted, within a specified time. For example, the arrival and/or transmission of packets may be required to satisfy certain delay constraints. Accordingly, if identical packets have arrived, are expected to arrive, and/or need to be transmitted at times that satisfy these delay constraints, then these packets may be determined (at 410) to be substantially identical. However, if the packets may not satisfy the delay constraints when they are delayed so that they may be fragmented and transmitted in a single set of messages indicated by a pseudo-address as discussed above, then these packets may not be determined (at 410) to be substantially identical.

If two or more of the packets are determined to be substantially identical, then one of the packets may be fragmented into messages that include a plurality of initial messages that are destined to a corresponding plurality of mobile units. Each of the plurality of initial messages includes a pseudo-address. The packets may also be fragmented into one or more subsequent messages that include the pseudo-address and portions of the packet payload, as discussed above. The initial messages may be transmitted (at 420) to the plurality of mobile units, which may access the pseudo-address in these messages. The subsequent messages may then be transmitted (at 425) to the plurality of mobile units, which may access these messages, and the payload portions, using the pseudo-address.

Packets associated with different streams that are not determined (at 510) to be identical may be fragmented into different sets of messages, which may be independently transmitted to the appropriate mobile unit or subset of mobile units. In the illustrated embodiment, the packets may be fragmented into initial messages that are addressed to a particular mobile units or a subset of mobile units. Each of the plurality of initial messages includes a pseudo-address. The packets may also be fragmented into one or more subsequent messages that include the pseudo-address and portions of the packet payload, as discussed above. The initial messages may be transmitted (at 430) to the mobile unit(s), which may access the pseudo-address in these messages. The subsequent messages may then be transmitted (at 435) to the mobile unit(s), which may access these messages, and the payload portions, using the pseudo-address.

Embodiments of the techniques described herein may combine advantages of the point-to-point and point-to-multipoint techniques, while reducing or eliminating many of the disadvantages associated with these approaches. On one hand, fragmenting identical packets into a single set of messages indicated by a pseudo-address that allows multiple mobile units to access the information in these messages may reduce or eliminate the redundant transmission of identical information, particularly when multiple identical streams of data are transmitted to a plurality of mobile units served by the same base station. By removing or reducing the redundant transmission of payloads from identical packets in multiple streams, the capacity of the air interface may be increased and scarce radio resources may be conserved. On the other hand, using pseudo-addresses to address non-identical information to individual mobile units and/or subset of mobile units may permit multicast and/or broadcast information to be personalized and/or tailored to the needs or wants of specific audiences.

Implementing separate pseudo-addresses for transmitting messages to groups of users and subset of users within these groups may also allow wireless communication systems to provide information more efficiently. For example, the pseudo-address of a group of users may be used to direct messages to access points that can transmit these messages over a relatively large cell or coverage area, which may include a large percentage of the group of users. The pseudo-addresses associated with individual users or subsets of users may then be used to direct messages to access points that can transmit the messages to particular cells, or portions of cells, that are likely to include the individual users or subsets of users. Furthermore, the pseudo-addresses may also be used to perform load balancing, e.g. by dynamically directing messages to access points that are experiencing a relatively low load.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
providing a plurality of first messages including information indicative of a first pseudo-address, each first message including information indicative of an address of one of a plurality of mobile units;
providing at least one second message including information indicative of at least one second pseudo-address and information indicative of the address of each mobile unit in at least one subset of the plurality of mobile units;
providing at least one third message including the first pseudo-address and a portion of a packet destined for the plurality of mobile units; and
providing at least one fourth message including the second pseudo-address and a portion of a packet destined for said at least one subset of the plurality of mobile units.

2. The method of claim 1, wherein providing the plurality of first messages comprises:
receiving a plurality of packets, each of the packets being destined for at least one the plurality of mobile units;
determining that a first portion of the plurality of packets are destined for all of the plurality of mobile units; and
determining that at least one second portion of the plurality of packets is destined for at least one subset of the plurality of mobile units.

3. The method of claim 2, wherein determining that the first portion of the plurality of packets are destined for all of the plurality of mobile units comprises determining that the first portion of the plurality of packets are substantially identical and wherein determining that said at least one second portion of the plurality of packets are destined for said at least one subset of the plurality of mobile units comprises determining that the second portion of the plurality of packets are substantially identical.

4. The method of claim 3, wherein determining that packets are substantially identical comprises at least one of comparing the contents of the packets, accessing tags included in the packets, comparing source addresses, destination ports, and error checking bits associated with the packets, and determining that a time difference between the substantially identical packets is within a selected tolerance.

5. The method of claim 1, wherein providing the plurality of first messages comprises providing information indicative of a first cell type and wherein providing said at least one third message comprises providing said at least one third message via transmission to a cell of the first cell type, and wherein providing said at least one second message comprises providing information indicative of a second cell type different than the first cell type and wherein providing said at least one fourth message comprises providing said at least one fourth message via transmission to a cell of the second cell type.

6. A method, comprising:
receiving, at a mobile unit included in a plurality of mobile units, a first message including information indicative of a first pseudo-address associated with the plurality of mobile units, the first message including information indicative of an address of the mobile unit;
receiving, at the mobile unit, at least one second message including information indicative of at least one second pseudo-address associated with a subset of the plurality of mobile units and information indicative of the address of the mobile unit, the subset including the mobile unit;
receiving, at the mobile unit, at least one third message including the first pseudo-address and a portion of a packet destined for the plurality of mobile units; and
receiving, at the mobile unit, at least one fourth message including the second pseudo-address and a portion of a packet destined for said at least one subset of the plurality of mobile units.

7. The method of claim 6, wherein receiving the first message comprises receiving information indicative of a first cell type and wherein receiving said at least one third message comprises receiving said at least one third message via transmission to a cell of the first cell type.

8. The method of claim 6, wherein receiving said at least one second message comprises receiving information indicative of a second cell type different than the first cell type and wherein receiving said at least one fourth message comprises receiving said at least one fourth message via transmission to a cell of the second cell type.

9. The method of claim 6, comprising combining the portions of the packet included in said at least one third message and the portions of the packet included in said at least one fourth message and forming output using the combined portions of the packet included in said at least one third message and the packet included in said at least one fourth message.
